(19) United States
(12) Patent Application Publication
(10) Pub. No.: US 2009/0298325 A1
(43) Pub. Date: Dec. 3, 2009

(54) ADAPTOR DEVICE

(76) Inventors: Joel JONKER, Rotterdam (NL); Tung Yan LAU, Shatin (HK)

Correspondence Address: OSTROLENK FABER GERB & SOFFEN, 1180 AVENUE OF THE AMERICAS, NEW YORK, NY, 100368403, US

(21) Appl. No.: 12/130,286

(22) Filed: May 30, 2008

(51) Int. Cl. H01R 13/72; H01R 31/06

(52) U.S. Cl. 439/501; 439/628

(57) ABSTRACT

The invention comprises an adaptor device incorporating a plurality of electrical connectors connectable to a power source. Each of the electrical plugs is configured for providing an electrical connection with an electric device according the manufacturer of that device's requirements. Each of the electrical connectors are moveable between a stored position in which they are retained within a housing in a position convenient for storage and/or transport, and an extended position in which they are engageable with an electronic device.

### CROSS REFERENCE TO RELATED APPLICATION

The present application is based on and claims benefit of U.S. Provisional Patent Application No. ______, filed Apr. 30, 2008, entitled “Adaptor Device,” the disclosure of which is hereby incorporated by reference.

### FIELD OF THE INVENTION

The present invention relates to an adaptor device for providing a selection of connectors suitable for making an electrical connection to provide electrical power to a selection of electrical and electronic devices. More particularly, but not exclusively it relates to an adaptor device which can be plugged into a power source and which provides a variety of connectors to allow the charging of batteries of powered devices or powering such devices.

### BACKGROUND TO THE INVENTION

Portable battery powered mobile devices are used extensively throughout the world. A person may carry a number of portable devices on his person at any one time, such may include personal digital assistants (PDAs), mobile phones, MP3 players, bluetooth headsets, and the like. Unfortunately, no universal plug adaptor protocol exists at present which allows the wide variety of devices to be charged or powered on a single plug type. However, frequently these various devices utilise the same voltage either for charging of batteries, or to run on.

For this reason, users are forced to retain a variety of charging plugs and associated charging cables. In order to overcome the above mentioned difficulties, products have become available on the markets which allow a variety of devices to be connected to a power source. One such product includes a plug for plugging into a power source, said plug being attached to a universal adaptor by means of a cable which is retractable into a housing. A number of loose plugs are then provided which may be fitted to the universal adaptor. These loose plugs contain connection points configured for connection to a variety of devices. A disadvantage of such a system is that the loose plugs tend to go missing, and that attached plug and universal adaptor do not provide a tidy solution for convenient transport and storage.

Other systems have been provided including a plug for connection to a power source, wherein the plug is attached to a universal adaptor by means of a retractable cable as described before. A multi-point plug is then provided which is capable of being plugged into the universal adaptor. The multipoint plug has a wide variety of plug points protruding from a central body in a radial direction. However, disadvantages associated with this system are that it is not generally suitable for convenient transport and storage. Further, protruding open connection points which are not plugged into a portable device to be charged may provide a safety hazard, or may be damaged.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or from part of the common general knowledge in the art.

### OBJECT OF THE INVENTION

It is an object of the present invention to provide an adaptor device which overcomes or at least ameliorates some of the above mentioned disadvantages, or which at least provide the public with a useful choice.

### SUMMARY OF THE INVENTION

In a first aspect the present invention broadly consists in an adaptor device suitable for interfacing a power source with an electronic device, said adaptor device comprising:

a housing;

a plurality of electrical connectors, each electrical connector being configured for connection to an electronic device, and wherein at least one electrical connector is movably engaged with said housing to move between
a stored position in which the electrical connector is at least partially retained within the housing for convenient storage or transport or both storage and transport, and
an extended position in which the electrical connector extends from the housing in a position suitable for connection to an electronic device, thereby to provide electrical power to the electronic device.

Preferably, at least one electrical connector is pivotally engaged with the housing to move between the stored position and the extended position.

Alternatively, at least one electrical connector is slidingly engaged with the housing to move between the stored position and the extended position.

Preferably, at least one of the electrical connectors is removably engaged with said housing.

Preferably, each of the electrical connectors is removably engaged with said housing.

Preferably, at least two of the electrical connectors are removably interchangeable with each other.

Preferably, each of the electrical connectors is removably interchangeable with each other.

Preferably, the adaptor device includes a power input connector for connection to a power source.

Preferably, the power input connector is attached to the housing by means of a power cable.

Preferably, the power cable is retractable into the housing by means of a winding mechanism.

Preferably, the winding mechanism includes a cable winder spool on which the cable is windable.

Preferably, the winding mechanism includes a biasing means for automatically retracting the power cable into the housing.

Preferably the cable winder spool is biased to rotate in a particular direction in order to retract the cable by a biasing means.

Preferably, the biasing means is a spring.

Preferably, the biasing means is a spiral leaf spring.

Alternately, the power cable is manually retractable into the housing by means of a manual winding mechanism.

Preferably, the adaptor device includes interengageable locking formations associated with the housing and the cable winder spool respectively to prevent retraction of the cable when it is withdrawn.

Preferably, the adaptor device includes an actuating mechanism which may be actuated to disengage the locking formations to allow retraction of the cable into the housing by the biasing means.

Preferably, the housing includes a securing mechanism, said securing mechanism being movable between a locked position, in which the electrical connectors are secured by the securing mechanism in their respective positions, and an unlocked position in which the electrical connectors are rendered movable between their stored positions and their extended positions.

Preferably, the securing mechanism also acts as a cover to protect the electrical connectors in their stored positions.

Preferably the securing mechanism is a hingeable lid assembly.

Preferably, the securing mechanism is releasable by actuation of a catch mechanism.

Preferably, power input connector is depressable when it is engaged with the housing, to act as an actuator for releasing the securing mechanism.

Preferably, at least one electrical connector is electrically connectable within the housing to the power input connector.

Preferably, at least one electrical connector is configured and adapted to be electrically connected to the power input connector when the electrical connector is in its extended position, and disconnected from the electrical power source when the electrical connector is in its stored position.

Preferably, at least one electrical connector is configured and adapted to be electrically connected to the power input connector when the electrical connector is in its extended position, and disconnected from the electrical power source when the electrical connector is in its stored position by means of a switching mechanism.

Preferably, at least one of the electrical connectors is pivotable on a pivot axle.

Preferably, the pivot axle is electrically conductive.

Preferably, the pivot axle is connectable to the power input connector.

Preferably, the adaptor device includes a transformer.

Preferably the transformer is integral with the power input connector.

Alternately, the transformer is integral with the housing.

Preferably, the transformer is configured for receiving mains electrical power from the power input connector and transforming it for use by an electronic device.

Preferably, the transformer is configured to transform mains power received from the power input connector and transform it into one of a selection of power protocols for use by an electronic device.

Preferably, the transformer is configured and adapted for stepping an input voltage to an output voltage.

Preferably, the transformer is configured and adapted for stepping an input voltage to one of a selection of output voltages.

Preferably, the adaptor device includes a rectifier which is configured and adapted for rectifying an input current from alternating current to direct current.

Alternately, the adaptor device includes a rectifier which is configured and adapted for rectifying an input current from direct current to alternating current.

Preferably the adaptor device includes a selection means for selecting one of a selection of power protocols to be output by the transformer to the electrical connector presented for use.

Preferably, the adaptor device includes a variable selection means for varying the power protocol to be output by the transformer to the electrical connector presented for use.

Preferably, the power input connector is a Universal Serial Bus (USB) plug.

In a second aspect, the invention broadly consists in a method of providing power to an electronic device from a power source via an adaptor device comprising a housing, a power input connector, and a plurality of electrical connectors that are individually moveably engaged with the housing and which are moveable between a stored position in which the electrical connector is at least partially retained within the housing, and an extended position in which the electrical connector extends from the housing for connection to an electronic device, said method comprising the steps of

matching an electronic device with an associated electrical connector suitable for engagement with the electronic device;

moving the associated electrical connector from its stored position to its extended position;

engaging the electrical connector with its associated electronic device;

connecting the power input connector to a power source.

Preferably, the housing includes a securing mechanism, said securing mechanism being movable between a locked position, in which the electrical connectors are secured in their respective positions, and an unlocked position in which the electrical connectors are rendered movable between their stored positions and their extended positions, and said method further comprises the steps of

moving the securing mechanism to its unlocked position, to allow movement of the associated electrical connector to its extended position; and

moving the associated electrical connector to its extended position.

Preferably, the method includes the step of moving the securing mechanism to its locked position, thereby preventing movement of the associated electrical connector to its stored position.

Preferably, the adaptor device includes a transformer which is selectable between a variety of power supply protocols by means of a switch, and the method includes the steps of

matching an electronic device to a power supply protocol; and

moving the switch to a setting associated with the selected power supply protocol.

Preferably, the power input connector is connectable to the housing by means of a power cable, and the power cable is retractable into the housing in a wound fashion, and the method includes the step of unwinding the wound power cable from the housing, before connecting the power input connector to the power source.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1a: shows a sequence of perspective views showing an adaptor device in various positions illustrating how a first electrical connector may be moved from its stored position to its extended position for connection;

FIG. 1b: shows a sequence of perspective views showing an adaptor device in various positions illustrating how a second electrical connector may be moved from its stored position to its extended position for connection;

FIG. 1c: shows a sequence of perspective views showing an adaptor device in various positions illustrating how a third electrical connector may be moved from its stored position to its extended position for connection;

FIG. 1d: shows a sequence of perspective views showing an adaptor device in various positions illustrating how a fourth electrical connector may be moved from its stored position to its extended position for connection;

FIG. 1e: shows a sequence of perspective views showing an adaptor device in various positions illustrating how a fifth electrical connector may be moved from its stored position to its extended position for connection;

FIG. 1f: shows a sequence of perspective views showing an adaptor device in various positions illustrating how a sixth electrical connector may be moved from its stored position to its extended position for connection;

FIG. 2: shows a perspective view of an adaptor device with the cover closed and all of the electrical connectors in their stored positions;

FIG. 3: shows a perspective view of an adaptor device with the cover partially opened and all of the electrical connectors in their stored positions;

FIG. 4: shows a perspective view of an adaptor device with the cover opened and all of the electrical connectors in their stored positions;

FIG. 5: shows a cutaway view of an adaptor device with the cover closed and engaged with the housing;

FIG. 6: shows a cutaway view of an adaptor device with the cover partially opened and the engaging formations released disengaged;

FIG. 7: shows a sequence of perspective views illustrating an adaptor device in various positions illustrating how the power input connector may be disengaged from the housing, and the power cable may be pulled from the housing;

FIG. 8: shows a sequence of cutaway plan views of the winding mechanism, illustrating how the winding mechanism may be moved to allow the power cable to be withdrawn from the housing;

FIG. 9: shows a sequence of perspective views showing an adaptor device in various positions illustrating how the power input connector may be engaged with the housing, and may be further depressed to cause retraction of the power cable;

FIG. 10: shows a sequence of cutaway plan views of the winding mechanism, illustrating how the coil spring is biased to retract the power cable after the power cable has been withdrawn from the housing;

FIG. 11: shows a sequence of cutaway perspective views of the winding mechanism, power input connector and power cable, illustrating how pulling on the power input connector to withdraw the power cable causes rotation of the cable winder spool to retract the cable;

FIG. 12: shows a sequence of cutaway plan views of the winding mechanism, illustrating how the engaging formations are disengaged with each other to allow retraction of the cable;

FIG. 13: shows a sequence of perspective views of the adaptor device, illustrating how the poser input connector is depressed to allow retraction of the cable;

FIG. 14: shows a sequence of cutaway perspective views showing how the power input connector is engaged with the winding mechanism to allow retraction of the cable;

FIG. 15: shows an exploded assembly view of an embodiment of an adaptor device; and

FIG. 16: shows a schematic circuit diagram of an embodiment of an adaptor device.

FIG. 17: shows a perspective top view of a second embodiment of the adaptor device with the cover closed and the electrical connectors in their stored positions;

FIG. 18: shows a perspective top view of a second embodiment of the adaptor device with the cover open and the electrical connectors in their stored positions;

FIG. 19: shows a perspective top view of a second embodiment of the adaptor device with the cover open and one of the electrical connectors moving towards its extended position;

FIG. 20: shows a perspective top view of a second embodiment of the adaptor device with the cover open and one of the electrical connectors in its extended position;

FIG. 21: shows a perspective top view of a second embodiment of the adaptor device with the cover closed and one of the electrical connectors in its extended position;

FIG. 22: shows a perspective bottom view of a second embodiment of the adaptor device with the cover closed and one of the electrical connectors in its extended position, and with the power input connector in its recess, and the power cable received into its channel;

FIG. 23: shows a perspective bottom view of a second embodiment of the adaptor device with the cover closed and one of the electrical connectors in its extended position, and with the power input connector removed from its recess and the power cable removed from its channel;

FIG. 24: shows a cutaway perspective view of a second embodiment of the adaptor device with the cover closed and the electrical connectors in their stored positions;

FIG. 25: shows a cutaway side view of a second embodiment of the adaptor device with the cover closed and the electrical connectors in their stored positions;

FIG. 26: shows a cutaway side view of a second embodiment of the adaptor device with the cover open and the electrical connectors in their stored positions;

FIG. 27: shows a cutaway side view of a second embodiment of the adaptor device with the cover open and one of the electrical connectors moving towards its extended position;

FIG. 28: shows a cutaway side view of a second embodiment of the adaptor device with the cover open and one of the electrical connectors in its extended position;

FIG. 29: shows a cutaway side view of a second embodiment of the adaptor device with the cover closed and one of the electrical connectors in its extended position;

FIG. 30: shows an exploded assembly view in perspective of a second embodiment of the adaptor device;

FIG. 31: shows a perspective view of a second embodiment of the adaptor device alongside removably interchangeable electrical connectors;

FIG. 32: shows a perspective view of a second embodiment of the adaptor device with one set of electrical connectors installed, with all of the electrical connectors in their extended positions; and

FIG. 33: shows a perspective view of a second embodiment of the adaptor device with a different set of electrical connectors installed, with all of the electrical connectors in their extended positions.

### DETAILED DESCRIPTION OF THE PREFERRED EMBODIMENT(S)

With reference to the above drawings, in which similar features are generally indicated by similar numerals, an adaptor device according to a first aspect of the invention is generally indicated by the numeral 100.

In one embodiment now described there is provided an adaptor device 100 suitable for interfacing a power source (not shown) with an electronic device (not shown). The adaptor device 100 comprises a housing 110; a plurality of electrical connectors 120, and a power input connector 130 connected to the housing 110 by means of a power cable 140.

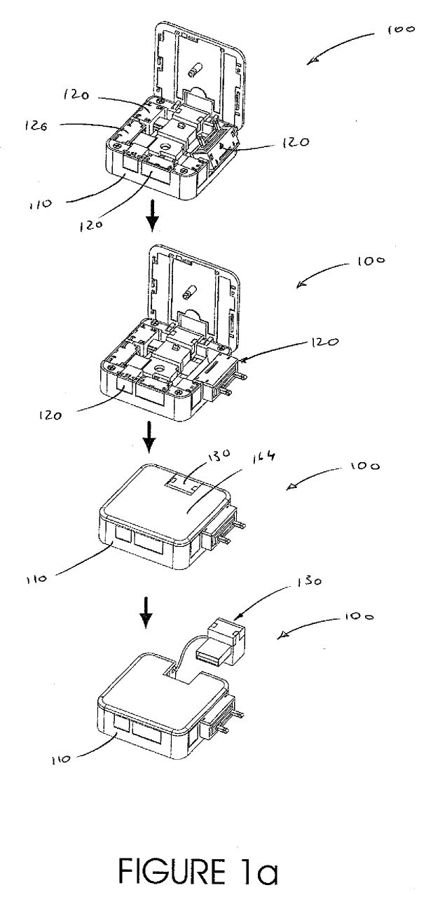

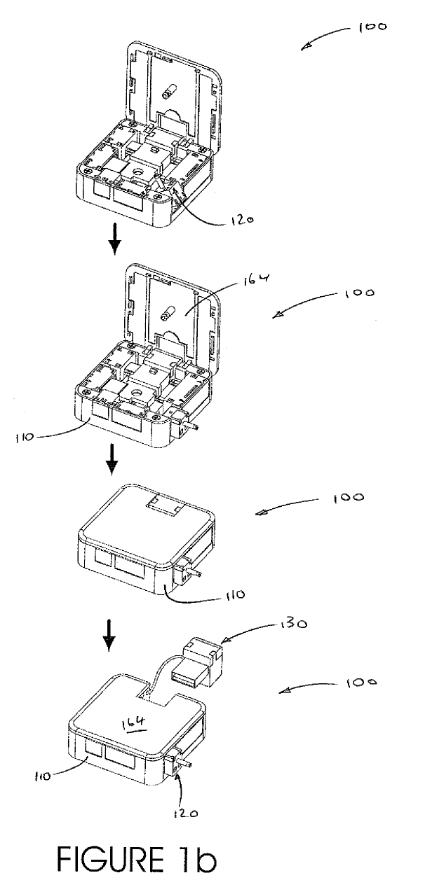

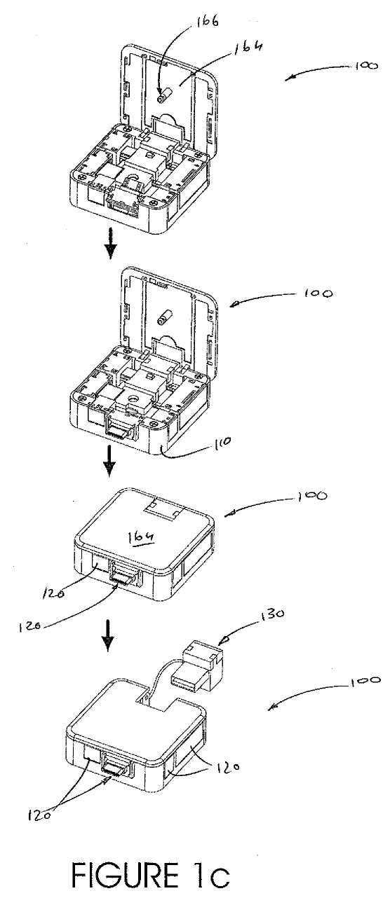

Each electrical connector 120 is configured for connection to an electronic device, and preferably a portable one such as a cellular telephone, a personal digital assistant (PDA), an MP3 Player, a laptop computer, accessories for these such as Bluetooth earpieces, and the like. Further, each electrical connector 120 is movably engaged with the housing 110 to move between a stored position (shown in FIG. 2) in which the electrical connector 120 is retained within the housing 110, and an extended position in which the electrical connector 120 extends from the housing 110 for connection to a portable electronic device. FIGS. 1a-1f show separate sequences of positions in which individual electrical connectors 120 are pivoted from their stored positions to their extended positions.

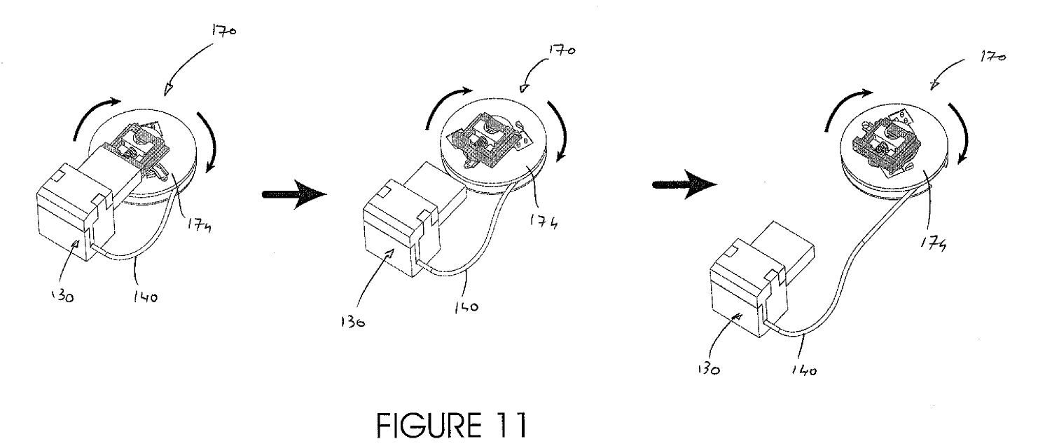

It is envisaged that the electrical connectors 120 could be moveably engaged with the housing in any number of ways. In the preferred embodiments shown in the figures, the electrical connectors 120 are pivotally engaged with the housing 110. Each electrical connector 120 is pivotally mounted on a pivot axle 122. It is envisaged that in one embodiment (not shown), the pivot axle 122 can be common to a plurality of electrical connectors 120, and will be composed of electrically conductive material, and is connected to the power input connector 130 to transfer an electrical connection to the electrical connectors 120. Alternately, in another embodiment (as shown in FIG. 16), electrical power can be transferred to the electrical connector 120 by a separate electrical switching mechanism 150 associated with each electrical connector 120.

The switching mechanism 150 comprises an electrical connecting formation 154 which is rotatable with the electrical connector 120 to move into contact with an electrical rail 156 when the electrical connector is in its extended position. When an electrical connector 120 is rotated on its pivot axle 122 towards its extended position, this causes an electrical connecting formation 154 to rotate as well, to bring the electrical connecting formation 154 into contact with the electrical rail 156. An electrical circuit diagram of the adaptor device is shown in FIG. 16. It is envisaged that the electrical rail could be provided in the form of a PCB board housed within the housing 110. It is further envisaged that a plurality of such electrical rails 156 could be provided within the housing 110 for this purpose.

In yet another embodiment (not shown), it is envisaged that the electrical connector 120 can be slidably moveable relative to the housing on a track (not shown).

In a preferred embodiment, the electrical connectors 120 are electrically connected to the power input connector 130 when the electrical connectors 120 are in their extended positions, and disconnected from the electrical power input connector 130 when the electrical connectors 120 are in their stored position. This will assist in preventing the possibility of any short circuits within the housing, caused by electrical connectors 120 accidentally making contact with each other.

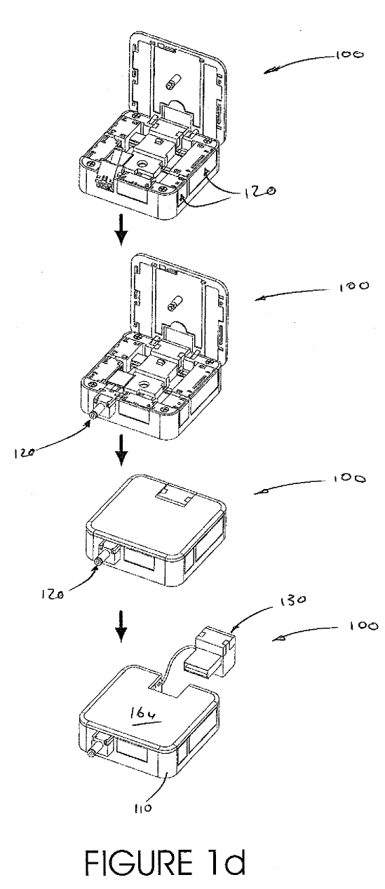

In preferred embodiment, the adaptor device will include a securing mechanism 160 engageable with the housing 110. In the embodiments shown in the figures, the securing mechanism 160 incorporates a hinged lid 164. The securing mechanism 160 is movable between a locked position (shown in FIG. 2), in which those electrical connectors 120 which are in their stored positions are secured in that position and those electrical connectors which are in their extended position are secured in their respective positions, and an unlocked position (shown in FIG. 4) in which the electrical connectors 120 are movable between their stored position and extended position. The lid 164 further serves as a cover to prevent ingress of water or dirt into the housing 110.

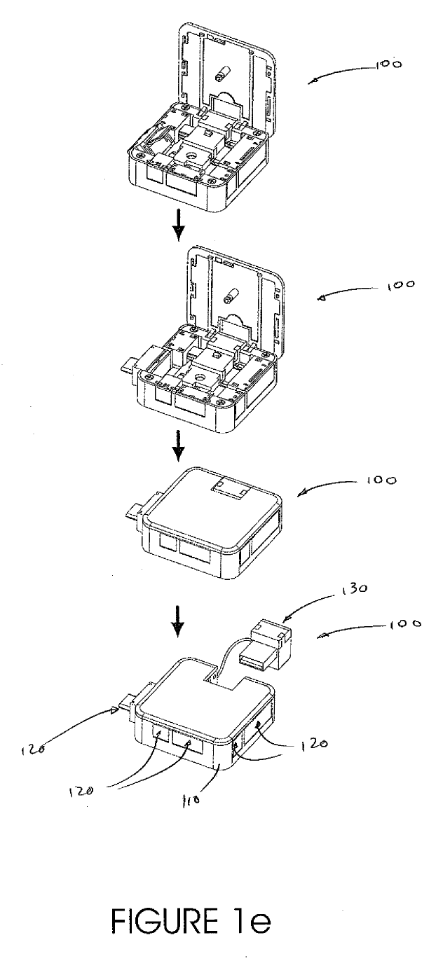

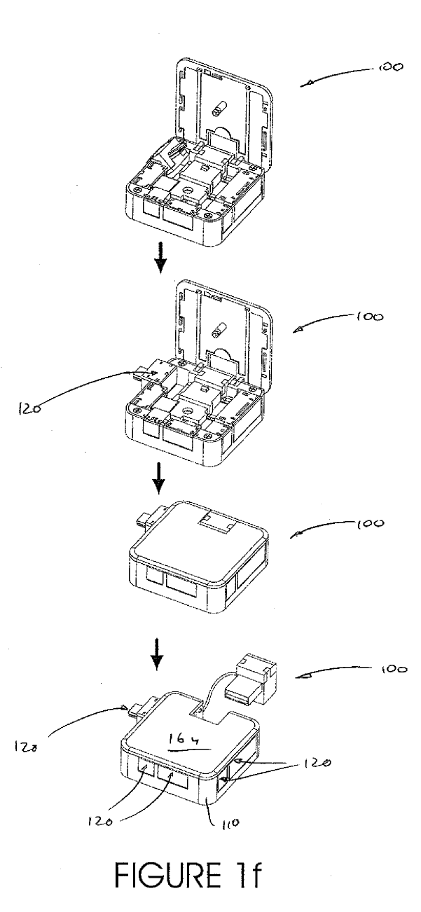

A latch formation 166 on the lid 164 (shown in FIG. 5-6) is engageable with a catch formation 168 on the housing 110. The catch formation 168 is biased by a spring 169 to engage with and secure the latch formation in a snap-fit fashion. As shown in sequence in FIGS. 5 and 6, the catch formation 168 can be disengaged from the latch formation 166 against the spring bias by pushing the power input connector 130 inwardly.

In an alternative embodiment of the invention, the securing mechanism 160 need not necessarily be a lid, nor even cover the electrical connectors 120 inside the housing 110 (although this is an advantage in that it looks neat and prevents the ingress of dirt, which may interfere with the engagement of the electrical connectors with their respective associated portable electronic devices). The securing mechanism 160 need only secure the electrical connectors in their respective positions when in the locked position. For this reason, the securing mechanism 160 could be embodied by any number of locking and unlocking mechanisms. Further, it is envisaged that the securing mechanism 160 could be used to prevent or allow (as the case may be) movement of individual electrical connectors 120 or all of them at once.

The power input connector 130 is adapted for connection to a power source, the power input connector 130 could be in any format, such as a mains plug (not shown), or as a USB port (as shown in the figures). The power supply could be a USB port on a computer (not shown), a mains electrical supply, or an uninterrupted power supply (UPS).

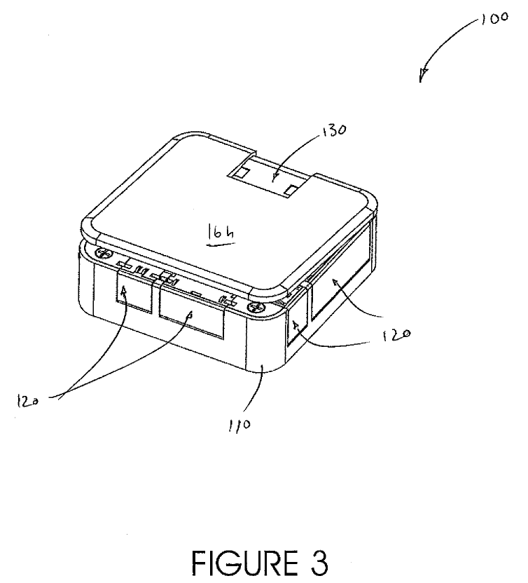

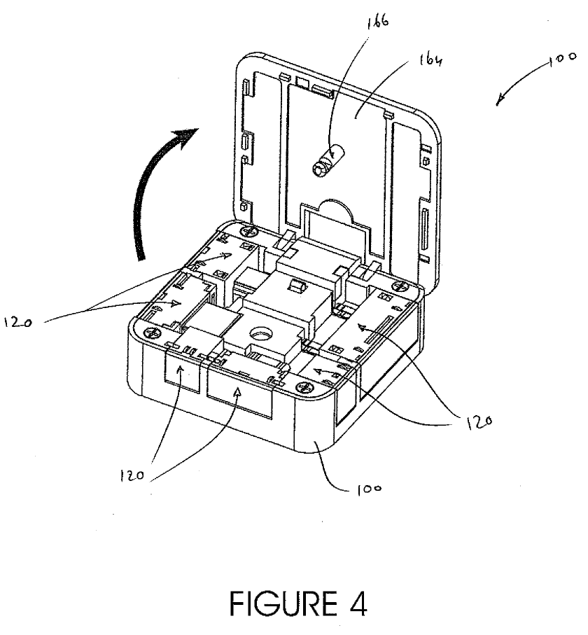

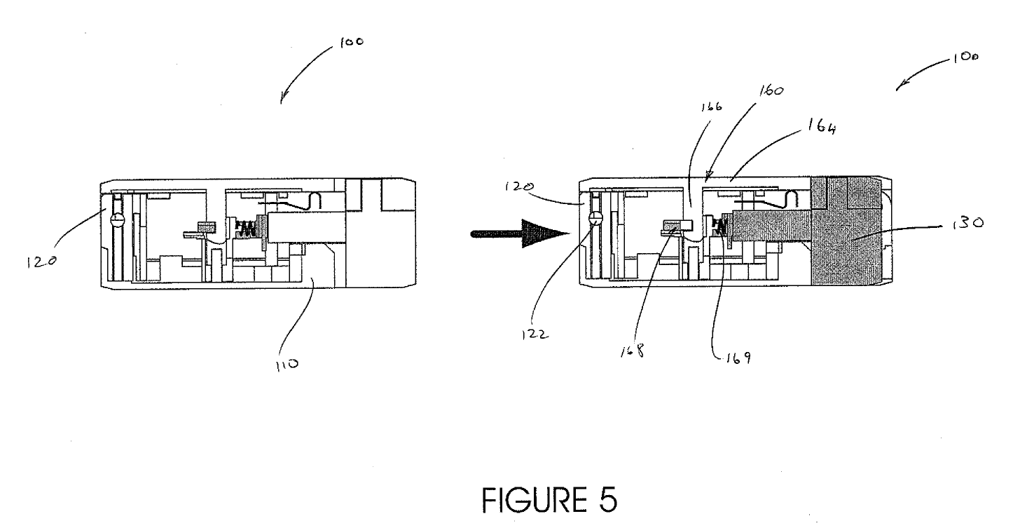

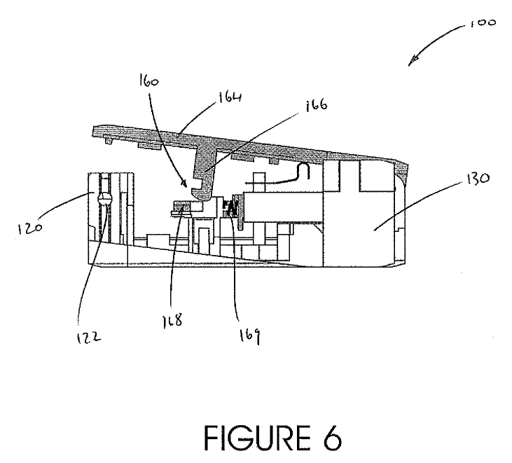

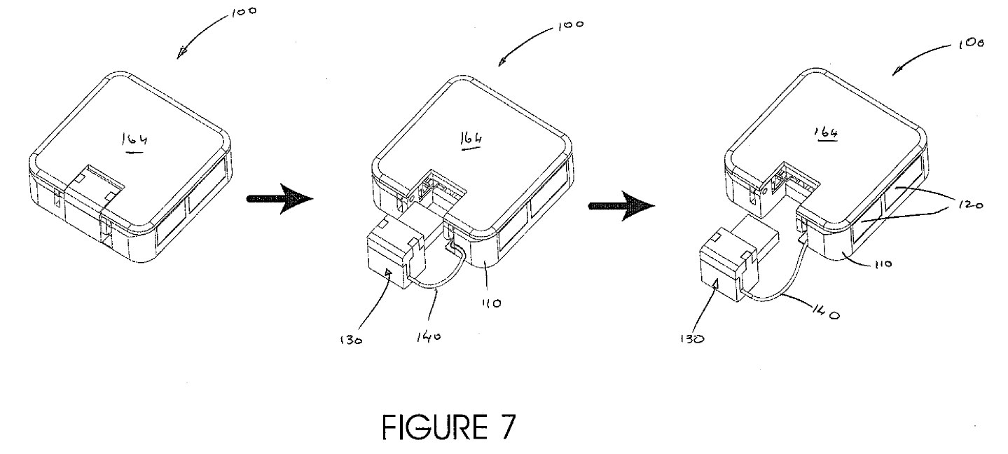

As mentioned before, the power input connector 130 is connected to the housing 110 by means of the power cable 140. The adaptor device includes a winding mechanism 170, which includes a rotatable cable winder spool 174 (shown in FIGS. 8 and 12) on which the cable 140 can be wound, and a spiral leaf spring 172 (shown in FIG. 10) for biasing the winder spool 174 to wind the cable 140 up on the winder spool 174, thereby retracting the cable 140 into the housing 110. As shown in FIG. 10, the spiral leaf spring is coupled to the cable winder spool 174, and is pulled into a more coiled configuration when the poser cable 140 is pulled from the housing 110.

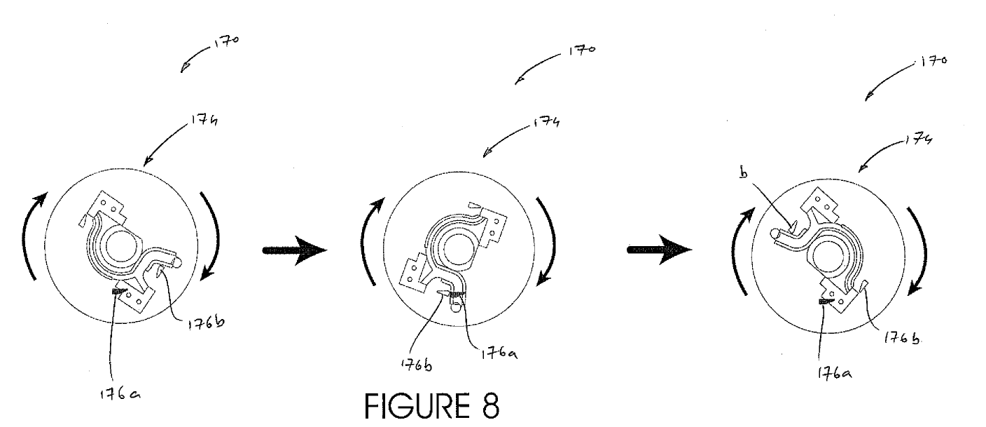

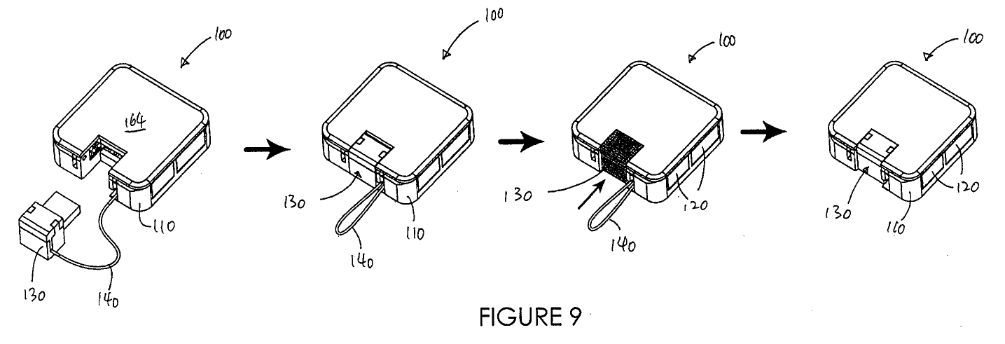

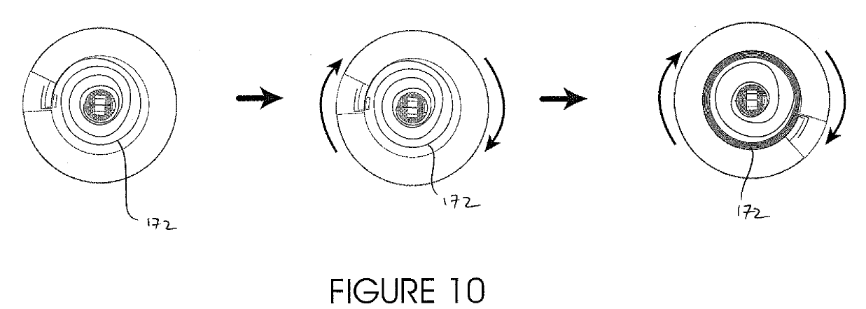

As the cable winder spool 174 is rotated by pulling on the power cable 140, locking formations 176a&b, on the housing 110 and the winder spool 174 respectively, engage with each other to prevent the spiral leaf spring 172 from retracting the cable 140. When the cable 140 is to be retracted into the housing 110 again, the power input connector 130 is engaged with the housing 110, and depressed (shown as arrow A in FIG. 12) against the action of the biasing spring 169, thereby disengaging the locking formations 176 a&b to allow the spiral leaf spring 172 to retract the cable 140. This sequence is illustrated in FIGS. 13, 14 and 15.

It is envisaged that the power cable 140 could also be retractable into the housing 110 by manual winding of the power cable 140 into the housing 110 on a manual winding device (not shown).

In yet another embodiment, it is envisaged that the adaptor device 100 could include a transformer (not shown) housed within the housing 110. The transformer is connected to the power input connector 130, and is configured for receiving electrical power (such as mains electrical power) from the power input connector 130 and transforming it for use by the into a suitable protocol for supply to a portable electronic device (normally at reduced voltage, such as between 0-10 volts) via the electrical connectors 120. It is envisaged that the transformer will be able to transform the power from the power input connector 130 into one of a selection of power protocols (i.e. particular combinations of voltages and currents). A switch (not shown) may be provided for selecting which of the available power protocols to use. Alternately, a variable selection means (not shown) may be provided for varying the power protocols on a continuously variable scale. It is envisaged that the transformer can be incorporated with the power input connector 130, or with the housing 110.

It is further envisaged that the adaptor device 100 could include a rectifier (not shown) which is able to rectify alternating current in direct current and/or vice versa.

It is envisaged that in operation, the adaptor device 100 will start with all electrical connectors 120 in their stored positions. A user (not shown) will match an electronic device with an associated electrical connector 120 which is configured for engagement with that electronic device. The lid 164 will be moved to the unlocked position, to allow access to and movement of the associated electrical connector 120. The associated electrical connector 120 will then be moved to its extended position, for engagement with its associated electronic device. This described sequence is shown in FIGS. 1a-1f for each of the various electrical connectors 120 in the adaptor device 100.

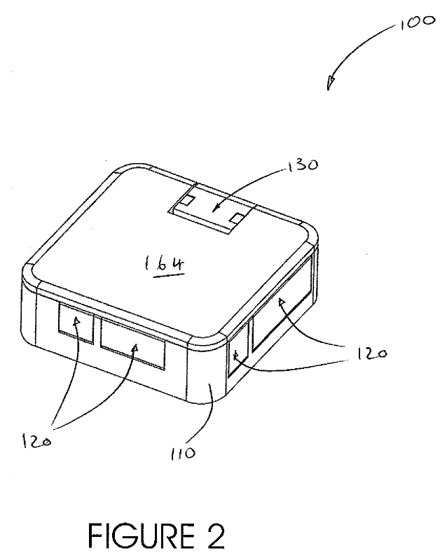

The power input connector 130 will also be connected to a power source by pulling the power cable out of the housing 110 against the bias of the spiral leaf spring 172 (as shown in sequence in FIG. 7), and connecting the power input connector 130 to the power source.

Where a transformer as described above is present, a suitable power protocol for the associated electronic device is selected by the user, by moving the switch to the appropriate setting.

Conversely, once the electronic device has been charged, or is no longer required to be powered, then the power input connector 130 can be disconnected from the power source, the power cable 140 is retracted into the housing by the biasing means by engaging the power input connector 130 with the housing 110 and depressing the power input connector 130 to disengage the locking formations 176a&b to retract the cable 140. The lid 164 is then moved to the unlocked position, the electrical connector 120 is pivoted back into the housing 110 into its stored position, and the lid 164 closed back into its locking position. The adaptor device 100 can then be conveniently stored or transported or both in this compact configuration.

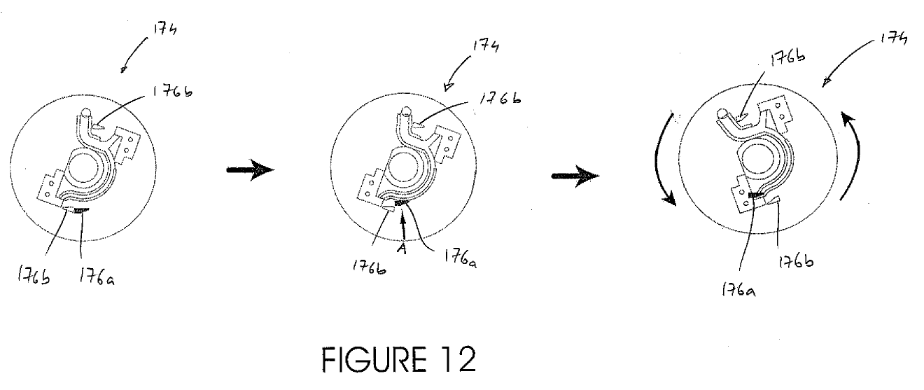

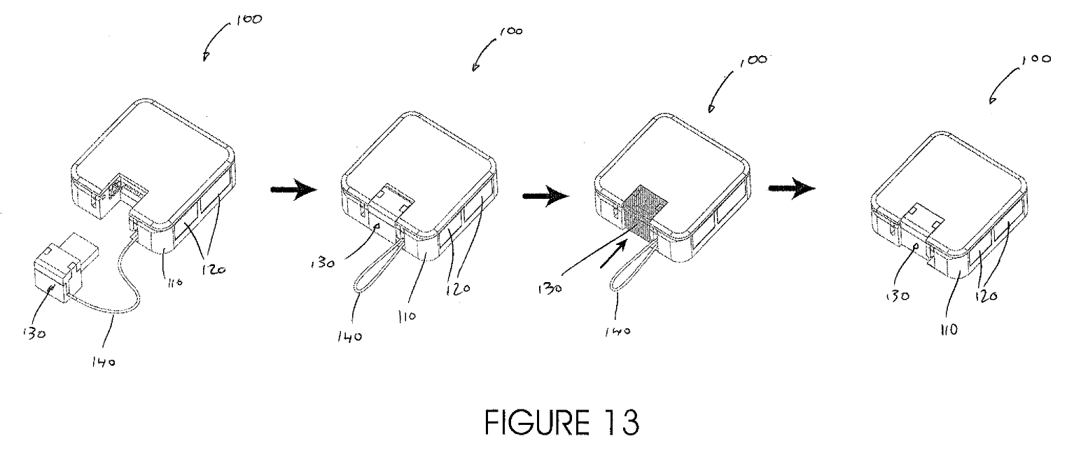

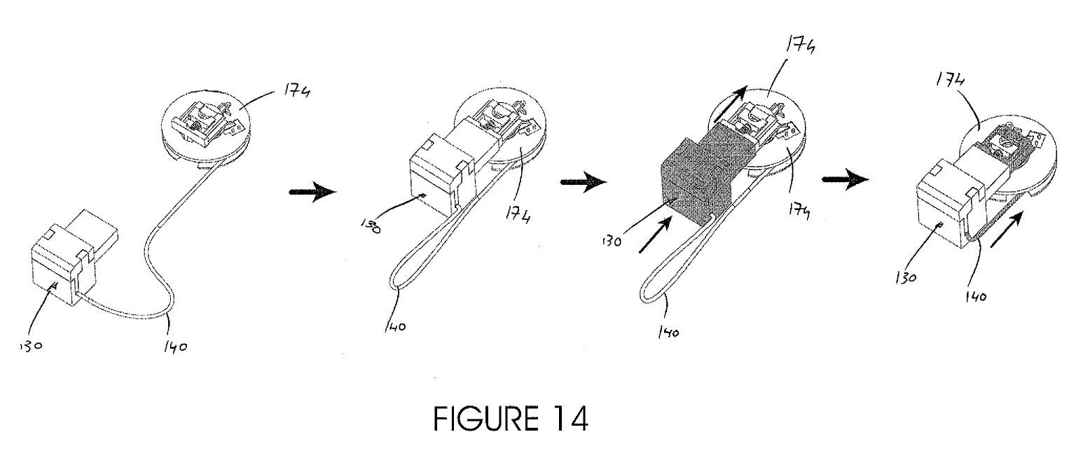

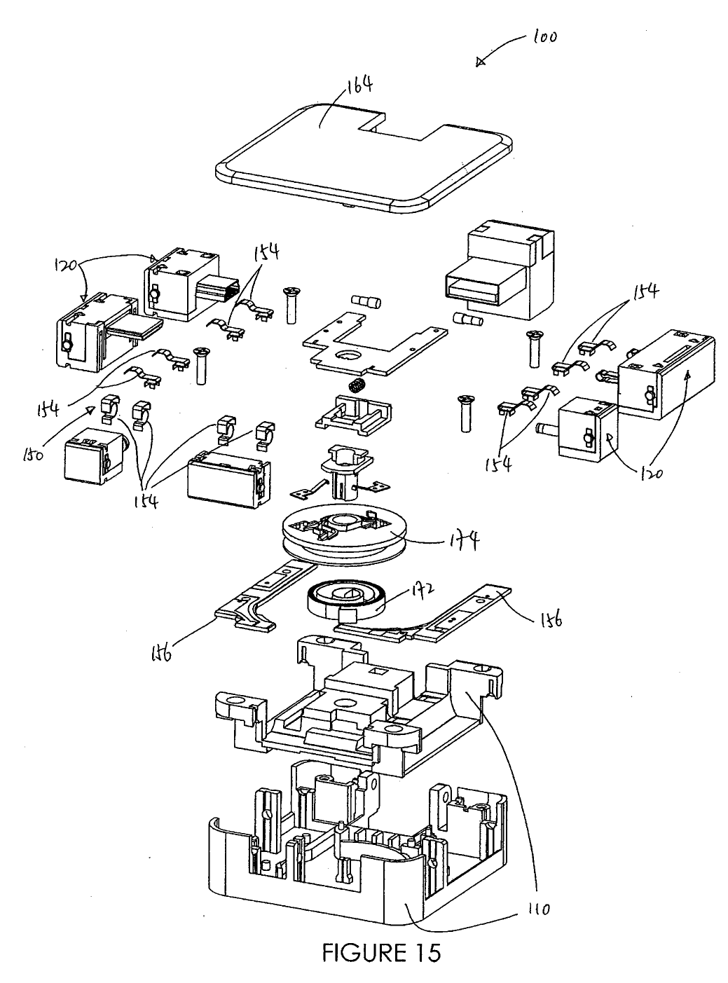

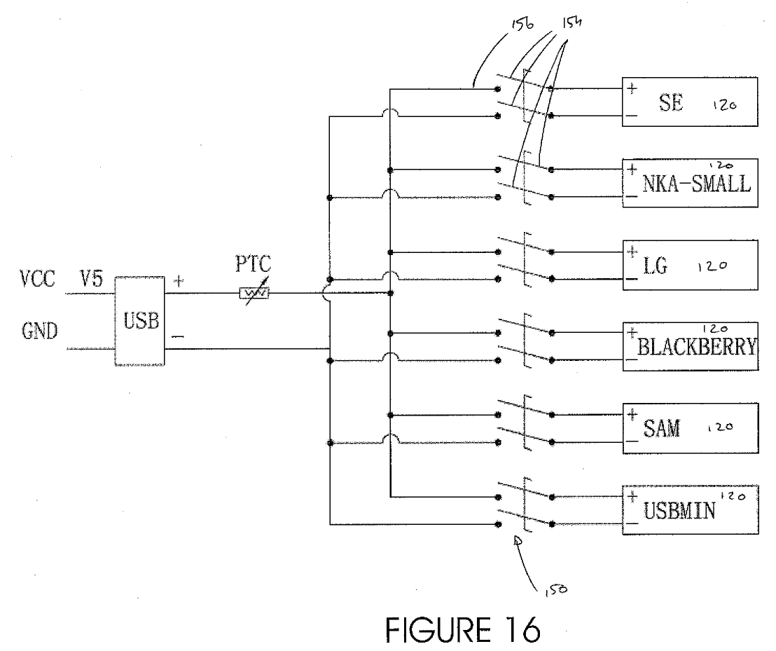

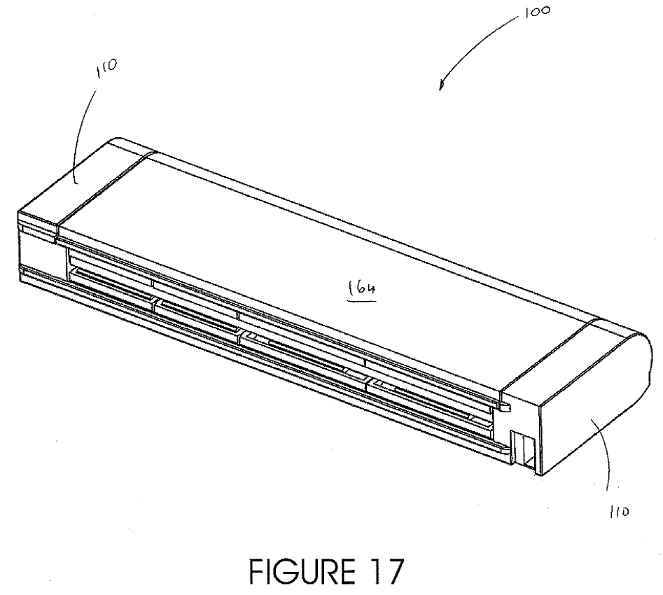

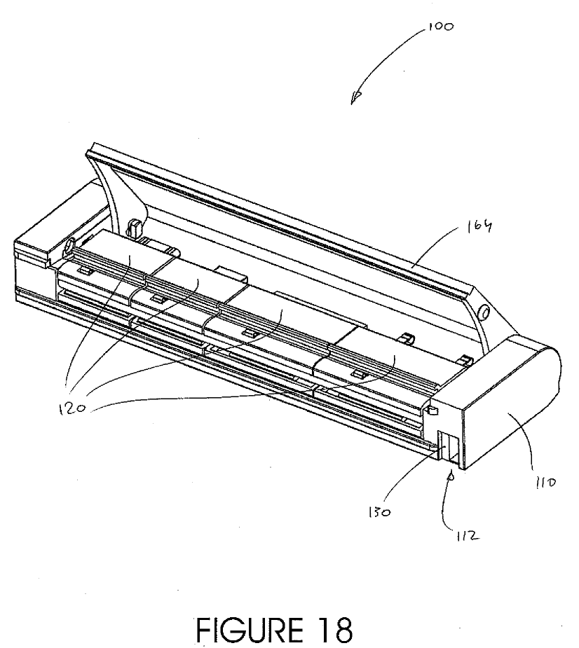

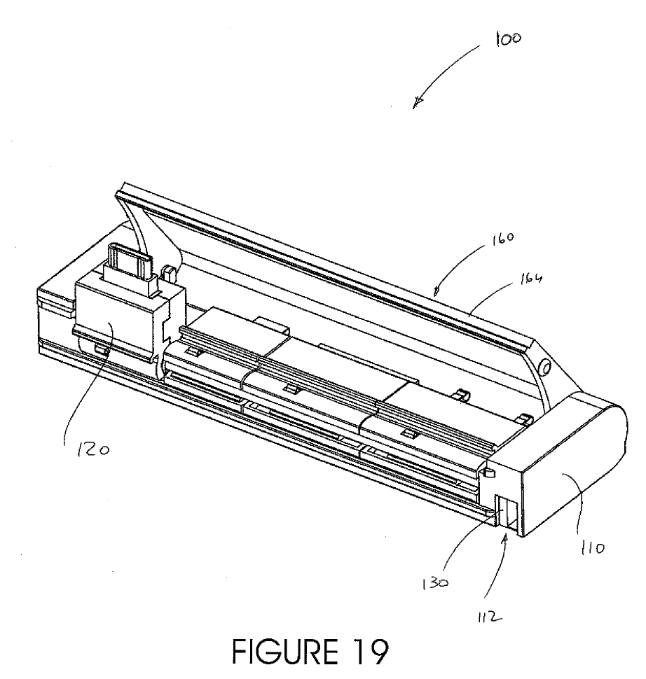

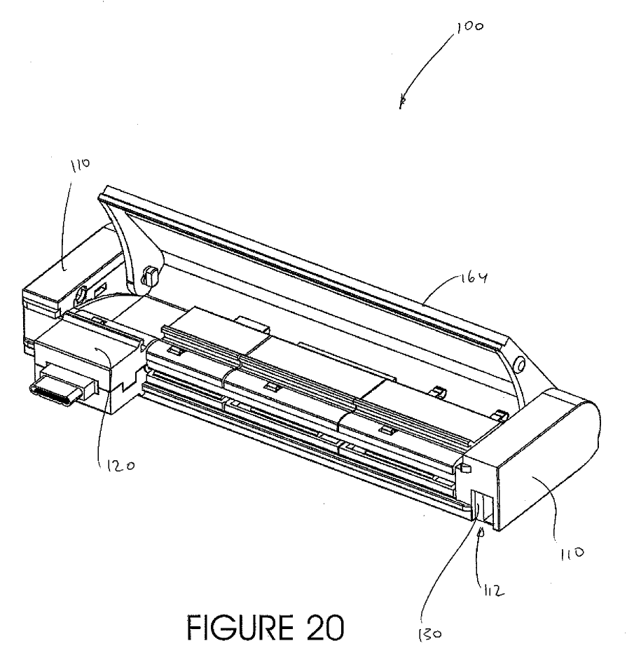

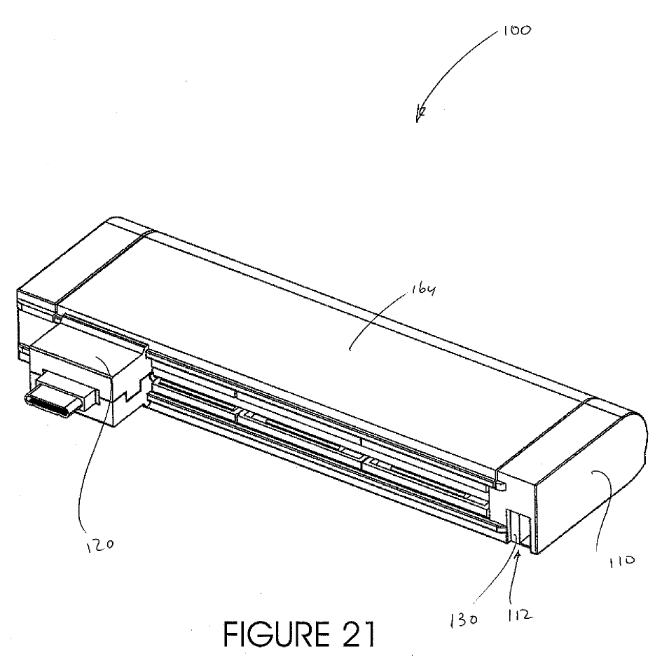

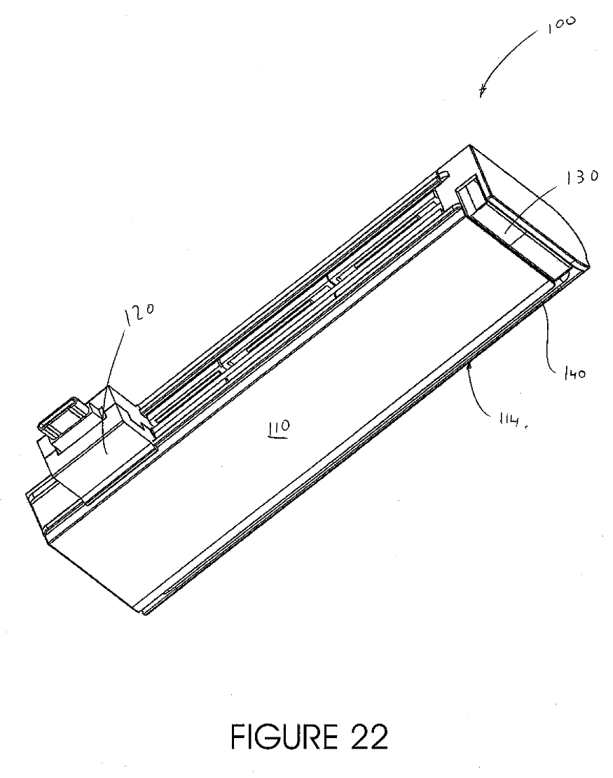

A second embodiment of an adaptor device 100 is shown in FIGS. 17-33 In this embodiment, only a single linear configuration of electrical connectors 120 is provided. The adaptor device 100 also has a securing mechanism 160 in the form of a lid or cover 164, which opens up to allow the electrical connectors 120 to move between a stored position and an extended position (shown in perspective view in sequence in FIGS. 17-21, and in cross sectional view in sequence in FIGS. 25-29). As may be clearly seen in FIGS. 25-29, the electrical connectors 120 are rotatable about a pivot axle 122 when the cover 164 is open.

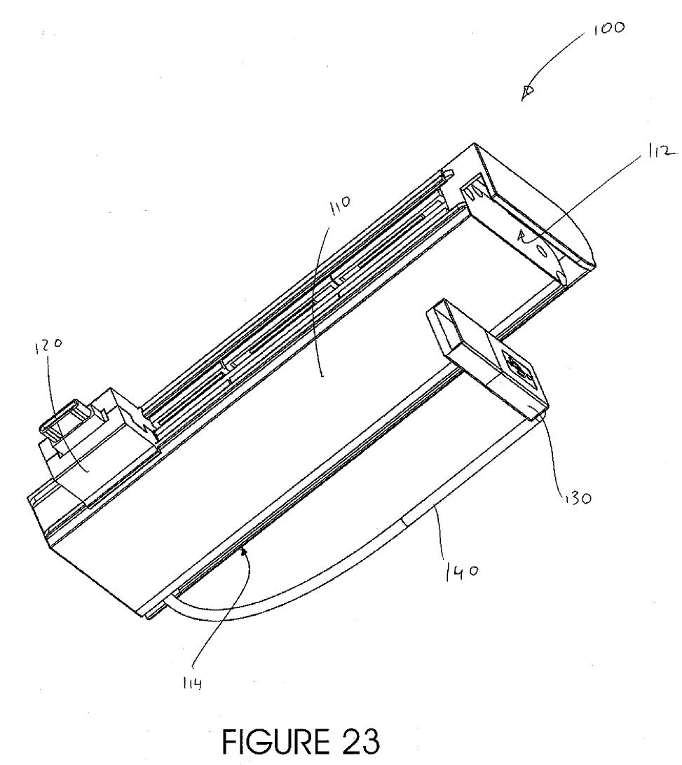

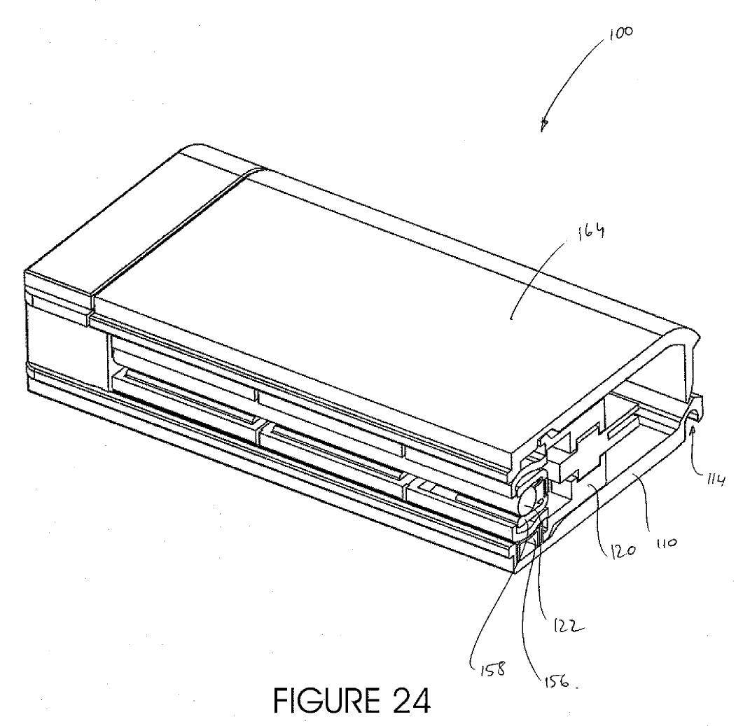

Further, the electrical connectors 120 only make an electrical connection with the power input connector 130 when the electrical connectors 120 are rotated fully into their extended position(shown in FIGS. 28 and 29), by virtue of an electrical switching mechanism 150 consisting of an electrical connecting formation 154 on the rotating electrical connector 120, which makes contact with an electrical rail 156 when the electrical connectors 120 are rotated fully into their extended position.

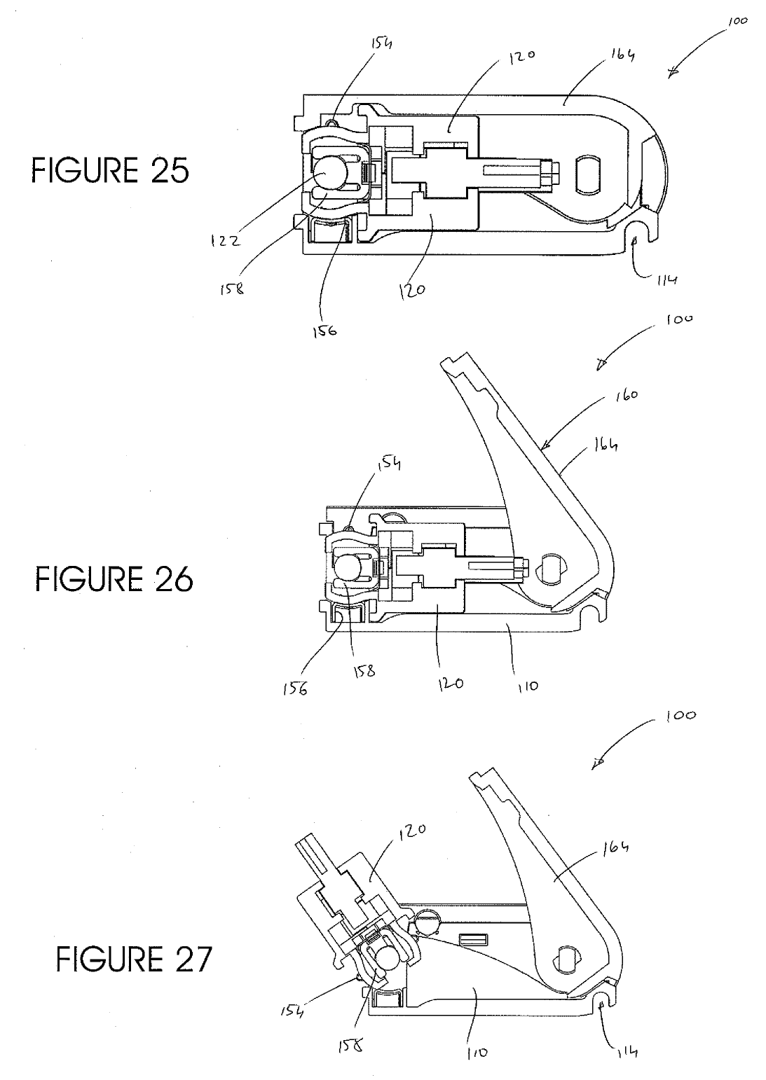

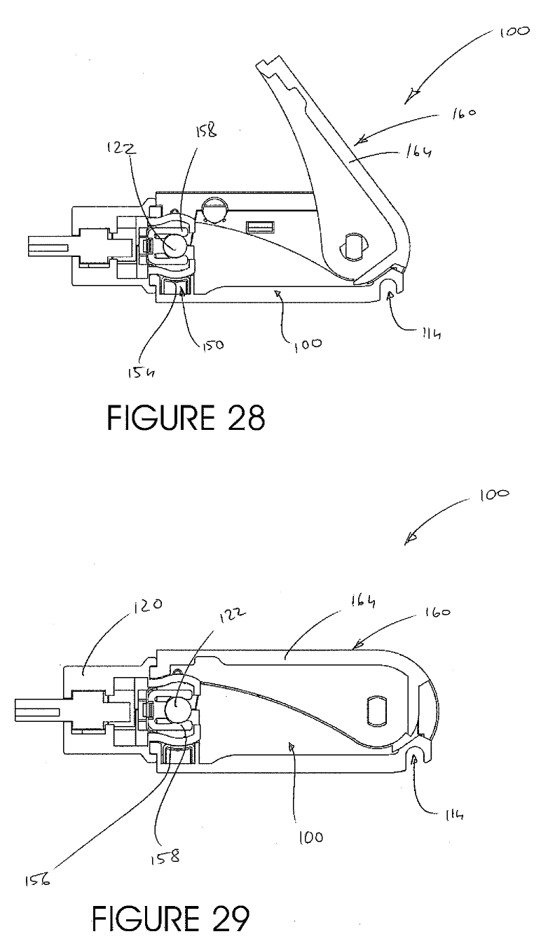

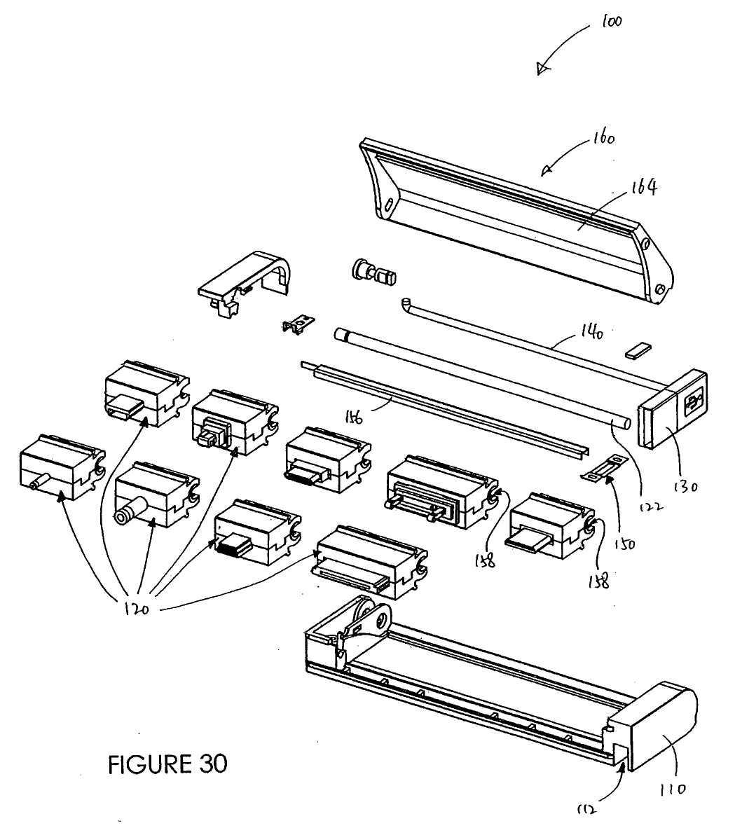

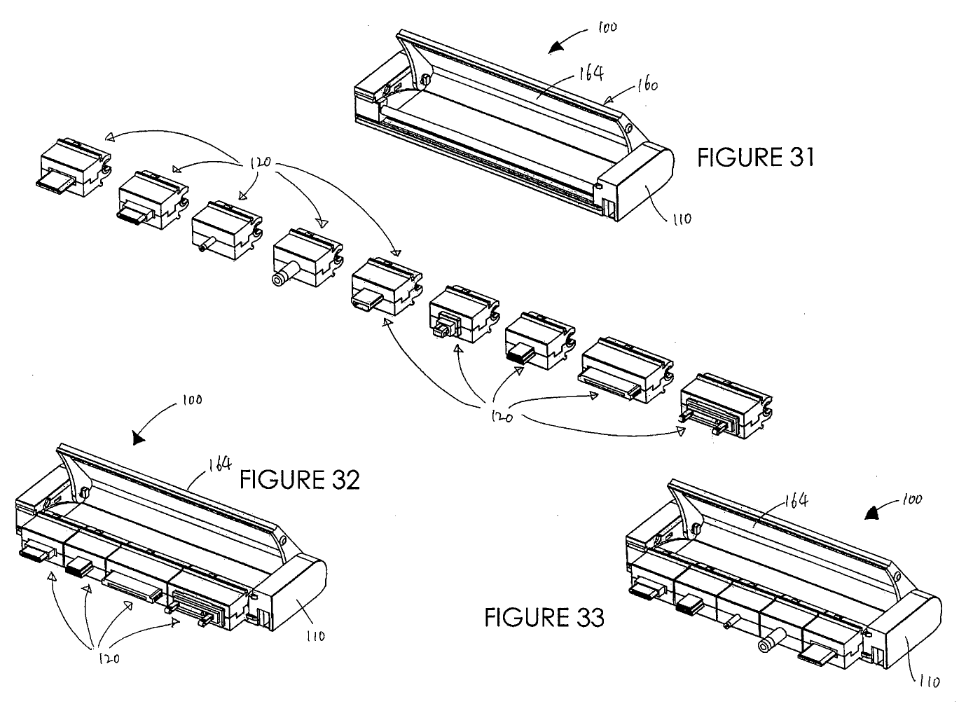

This embodiment emphasises a reduction in size of the adaptor device 100 for convenient transportation and storage purposes. For this reason, space is provided for only four to five electrical connectors 120 side by side in this embodiment. However, it is envisaged that each of these electrical connectors 120 will be interchangeable with any of the other electrical connectors (as shown in FIG. 30), and optionally with additional modules that may be provided with the adaptor device 100, or which may be provided as aftermarket modular accessories. In this way, a user may select the particular electrical connectors 120 that are most relevant for their purposes, and fit these connectors to the housing 110. FIG. 30 shows an exploded assembly view of the adaptor device 100 including nine different electrical connectors 120. The electrical connectors 120 can be disengaged from the housing 110 by means of snap fit formations 158 (shown in FIGS. 25-29) on the housing 110 and electrical connectors 120 respectively. FIG. 31 shows a range of electrical connectors 120 suitable for engagement with the housing 110. FIGS. 32 and 33 shows the same housing with various combinations of electrical connectors 120 engaged therewith.

Further, this embodiment does not include a winding mechanism 170 as shown in the first embodiment for automatically retracting the power cable 140 (although one could be included). Instead, the power cable 140 remains at a predetermined length, and the power input connector 130 on the end of the power cable 140 is received into a recess 112 on the housing 110, while the power cable 140 is received into a channel 114 in the housing 110 for that purpose. The power input connector 130 can be held in the recess 112 by a snap-fit type formation (not shown), or by a friction fit in the recess 112.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

We claim:

1. An adaptor device suitable for interfacing a power source with an electronic device, said adaptor device comprising:
a housing;
a plurality of electrical connectors, each electrical connector being configured for connection to an electronic device, and wherein at least one electrical connector is movably engaged with said housing to move between
a stored position in which the electrical connector is at least partially retained within the housing for convenient storage or transport or both storage and transport, and
an extended position in which the electrical connector extends from the housing in a position suitable for connection to an electronic device, thereby to provide electrical power to the electronic device.

2. An adaptor device as claimed in claim 1, wherein at least one electrical connector is pivotally engaged with the housing to move between the stored position and the extended position.

3. An adaptor device as claimed in claim 1, wherein at least one electrical connector is slidingly engaged with the housing to move between the stored position and the extended position.

4. An adaptor device as claimed in claim 1, wherein at least one of the electrical connectors is removably engaged with said housing.

5. An adaptor device as claimed in claim 4, wherein each of the electrical connectors is removably engaged with said housing.

6. An adaptor device as claimed in any of claims 1, wherein at least two of the electrical connectors are removably interchangeable with each other.

7. An adaptor device as claimed in claim 6, wherein each of the electrical connectors is removably interchangeable with each other.

8. An adaptor device as claimed in claim 1, wherein the adaptor device includes a power input connector for connection to a power source.

9. An adaptor device as claimed in claim 8, wherein the power input connector is attached to the housing by means of a power cable.

10. An adaptor device as claimed in claim 9, wherein the power cable is retractable into the housing by means of a winding mechanism.

11. An adaptor device as claimed in claim 10, wherein the winding mechanism includes a cable winder spool on which the power cable is windable.

12. An adaptor device as claimed in claim 10, wherein the winding mechanism includes a biasing means for automatically retracting the power cable into the housing.

13. An adaptor device as claimed in claim 12, wherein the cable winder spool is biased to rotate in a particular direction in order to retract the cable by the biasing means.

14. An adaptor device as claimed in claim 13, wherein the biasing means is a spring.

15. An adaptor device as claimed in claim 14, wherein the biasing means is a spiral leaf spring.

16. An adaptor device as claimed in claim 10, wherein the power cable is manually retractable into the housing by means of a manual winding mechanism.

17. An adaptor device as claimed in claim 11, wherein the adaptor device includes interengageable locking formations associated with the housing and the cable winder spool respectively to prevent retraction of the cable into the housing after it is withdrawn.

18. An adaptor device as claimed in claim 17, wherein the adaptor device includes an actuating mechanism which may be actuated to disengage the locking formations to allow retraction of the cable into the housing by the biasing means.

19. An adaptor device as claimed in claims 1, wherein the housing includes a securing mechanism, said securing mechanism being movable between
a locked position, in which the electrical connectors are secured by the securing mechanism in their respective positions, and
an unlocked position in which the electrical connectors are rendered movable between their stored positions and their extended positions.

20. An adaptor device as claimed in claim 19, wherein the securing mechanism incorporates a lid assembly which acts as a cover to protect the electrical connectors in their stored positions.

21. An adaptor device as claimed in claim 20, wherein the lid assembly is hingeable.

22. An adaptor device as claimed in claim 19, wherein the securing mechanism is releasable by actuation of a catch mechanism.

23. An adaptor device as claimed in claim 22, wherein the power input connector is depressable when it is engaged with the housing, to act as an actuator for releasing the securing mechanism.

24. An adaptor device as claimed in claim 8, wherein at least one electrical connector is electrically connectable within the housing to the power input connector.

25. An adaptor device as claimed in claim 8, wherein at least one electrical connector is configured and adapted to be electrically connected to the power input connector when the electrical connector is in its extended position, and disconnected from the electrical power source when the electrical connector is in its stored position by means of a switching mechanism.

26. An adaptor device as claimed in claims 2, wherein at least one of the electrical connector is pivotable on a pivot axle.

27. An adaptor device as claimed in claim 26, wherein the pivot axle is electrically conductive.

28. An adaptor device as claimed in claim 27, wherein the pivot axle is connectable to the power input connector.

29. An adaptor device as claimed in claim 1, wherein the adaptor device includes a transformer.

30. An adaptor device as claimed in claim 29, wherein the transformer is incorporated with the power input connector.

31. An adaptor device as claimed in claim 29, wherein the transformer is incorporated with the housing.

32. An adaptor device as claimed in claim 29, wherein the transformer is configured for receiving mains electrical power from the power input connector and transforming it for use by the into a protocol suitable for use by an electronic device.

33. An adaptor device as claimed in claim 29, wherein the transformer is configured to transform mains power received from the power input connector and transform it into one of a selection of power protocols for use by an electronic device.

34. An adaptor device as claimed in claim 29, wherein the transformer is configured and adapted for stepping an input voltage to an output voltage.

35. An adaptor device as claimed in claim 29, wherein the transformer is configured and adapted for stepping an input voltage to one of a selection of output voltages.

36. An adaptor device as claimed in claim 29, wherein the adaptor device includes a selection means for selecting one of a selection of power protocols to be output by the transformer to the electrical connector presented for use.

37. An adaptor device as claimed in claim 29, wherein the adaptor device includes a variable selection means for varying the power protocol to be output by the transformer to the electrical connector presented for use.

38. An adaptor device as claimed in claim 1, wherein the adaptor device includes a rectifier which is configured and adapted for rectifying an input current from alternating current to direct current.

39. An adaptor device as claimed in claim 1, wherein the adaptor device includes a rectifier which is configured and adapted for rectifying an input current from direct current to alternating current.

40. An adaptor device as claimed in claim 8, wherein the power input connector is a Universal Serial Bus (USB) plug.

41. An adaptor device as claimed in claim 4, wherein at least one of the electrical connectors is removably engaged with said housing by means of snap-fit formations.

42. A method of providing power to an electronic device from a power source via an adaptor device comprising a housing, a power input connector, and a plurality of electrical connectors that are individually moveably engaged with the housing and which are moveable between a stored position in which the electrical connector is at least partially retained within the housing, and an extended position in which the electrical connector extends from the housing for connection to an electronic device, said method comprising the steps of
matching an electronic device with an associated electrical connector suitable for engagement with the electronic device;
moving the associated electrical connector from its stored position to its extended position;
engaging the electrical connector with its associated electronic device; and
connecting the power input connector to a power source.

43. A method as claimed in claim 42, wherein the housing includes a securing mechanism, said securing mechanism being movable between a locked position, in which the electrical connectors are secured in their respective positions, and an unlocked position in which the electrical connectors are rendered movable between their stored positions and their extended positions, and said method further comprises the steps of
moving the securing mechanism to its unlocked position, to allow movement of the associated electrical connector to its extended position; and
moving the associated electrical connector to its extended position.

44. A method as claimed in claim 43, wherein the method includes the step of moving the securing mechanism to its locked position, thereby preventing movement of the associated electrical connector to its stored position.

45. A method as claimed in claim 42, wherein the adaptor device includes a transformer which is selectable between a variety of power supply protocols by means of a selection means, and the method includes the steps of
matching an electronic device to a power supply protocol; and
moving the selection means to a setting associated with the selected power supply protocol.

46. A method as claimed in claim 42, wherein the power input connector is connectable to the housing by means of a power cable, and the power cable is retractable into the housing in a wound fashion, and the method includes the step of unwinding the wound power cable from the housing, before connecting the power input connector to the power source.

47. An electrical connector adapted and configured for engagement with a housing, said electrical connector comprising engagement formations for moveably engaging with said housing between
a stored position in which the electrical connector is at least partially retained within the housing for convenient storage or transport or both storage and transport, and
an extended position in which the electrical connector extends from the housing in a position suitable for connection to an electronic device.

48. An electrical connector as claimed in claim 47, wherein the engagement formations are configured and adapted for removable engagement with said housing.

49. An electrical connector as claimed in claim 47, wherein the engagement formations are configured and adapted for moveable engagement with said housing.

50. An electrical connector as claimed in claim 49, wherein the engagement formations are configured and adapted for pivotable engagement with said housing.

51. An electrical connector as claimed in claim 49, wherein the engagement formations are configured and adapted for sliding engagement with said housing.

52. An electrical connector as claimed in claim 49, wherein the engagement formations are configured and adapted for toggling an electrical connection with an electrical connector in said housing when moving between their stored position and their extended position.
